(19) United States
(12) Patent Application Publication
(10) Pub. No.: US 2007/0156775 A1
(43) Pub. Date: Jul. 5, 2007

(54) Metadata transformation in copy and paste scenarios between heterogeneous applications

(76) Inventor: IIja Fischer, Heidelberg (DE)

Correspondence Address: KENYON & KENYON LLP, RIVERPARK TOWERS, SUITE 600, 333 W. SAN CARLOS ST., SAN JOSE, CA, 95110, US

(21) Appl. No.: 11/319,509

(22) Filed: Dec. 29, 2005

(51) Int. Cl. G06F 17/30

(52) U.S. Cl. 707/201

(57) ABSTRACT

A system and method for altering metadata during the transfer of an associated subset of data. A transfer function may duplicate a subset of data from a first location in a first set of data for a first metadata-capable software application. The transfer function may automatically alter a set of metadata associated with the subset of data. The transfer function may add the subset of data to a second location.

### BACKGROUND

The present invention relates to a system for the transfer of data within a program and between programs, and, in particular, altering metadata associated with the data.

One of the most common uses of modern computing is the display of a set of data in a form easily understandable by a user. The data displayed, however, is not always the sum total of the data affected by a particular computer program. One form of hidden data that may often be used is metadata. Metadata is a subset of data associated with a set of displayed data. Metadata may include a history of changes made to the set of data, the identity of the user making the changes, sources of the data, and other data that may not necessarily be a part of the set of data but may comment on the production of the set of data.

Most programs that allow for the transfer of data, through such methods as a cut-and-paste function, a copy-and-paste function, or a drag-and-drop function, will also transfer metadata along with the regular data. If the data is being transferred between programs that are metadata-enabled, the metadata will be transferred as well. This is not always desirable.

One method currently used to strip metadata from a set of regular data is to transfer the set of regular data to a program that is not metadata enabled before transferring the data to a metadata enabled program. Another option is to run a metadata stripping function once the data has been transferred to the metadata enabled program.

What is needed is a method of altering the metadata associated with a subset of data simultaneous with transferring the data within a program or between programs.

### BRIEF DESCRIPTION OF THE DRAWINGS

FIG. 1 illustrates a possible configuration of a computer system to implement the application components under the present invention.

FIG. 2 illustrates in a block diagram one embodiment for a method of removing metadata.

FIG. 3 illustrates in a block diagram one embodiment for a method of adding metadata.

FIG. 4 illustrates in a flowchart one embodiment of a method for altering metadata simultaneous with the transfer of data.

### DETAILED DESCRIPTION

A system and method for altering metadata during the transfer of an associated subset of data. A transfer function may duplicate a subset of data from a first location in a first set of data for a first metadata-capable software application. The transfer function may automatically alter a set of metadata associated with the subset of data. The transfer function may add the subset of data to a second location.

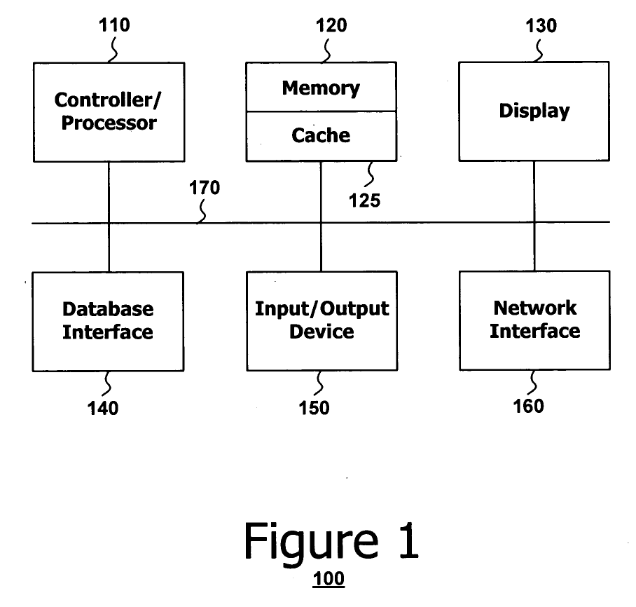

FIG. 1 illustrates a possible configuration of a computer system 100 to implement application components under the present invention. The computer system 100 may include a controller/processor 110, a memory 120 with a cache 125, display 130, database interface 140, input/output device interface 150, and network interface 160, connected through bus 170.

The controller/processor 110 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 120 may include volatile and nonvolatile data storage, including one or more electrical, magnetic or optical memories such as a RAM, cache, hard drive, CD-ROM drive, tape drive or removable storage disk. The memory may have a cache 125 to speed access to specific data.

The Input/Output interface 150 may be connected to one or more input devices that may include a keyboard, mouse, pen-operated touch screen or monitor, voice-recognition device, or any other device that accepts input. The Input/Output interface 150 may also be connected to one or more output devices, such as a monitor, printer, disk drive, speakers, or any other device provided to output data.

The network interface 160 may be connected to a communication device, modem, network interface card, a transceiver, or any other device capable of transmitting and receiving signals over a network. The components of the computer system 100 may be connected via an electrical bus 170, for example, or linked wirelessly.

Client software and databases may be accessed by the controller/processor 110 from memory 120 or through the database interface 140, and may include, for example, database applications, word processing applications, the client side of a client/server application such as a billing system, as well as components that embody the decision support functionality of the present invention. The computer system 100 may implement any operating system, such as Windows or UNIX, for example. Client and server software may be written in any programming language, such as ABAP, C, C++, Java or Visual Basic, for example.

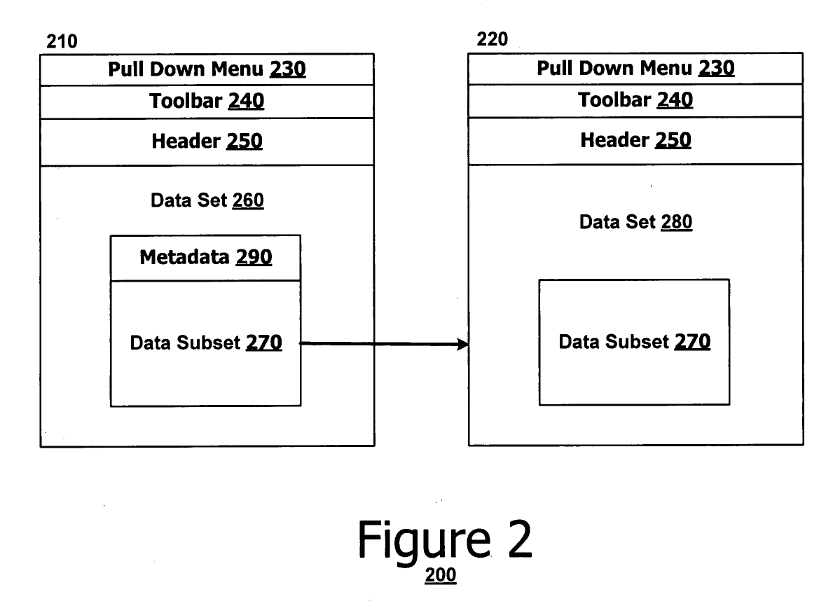

FIG. 2 illustrates in a block diagram one embodiment for a method 200 of removing metadata. A computer system 100 may be executing a first program 210 and a second program 220. The first program 210 and the second program 220 may be shown as separate windows on the display 130 or may be shown to the user in some other fashion. Each program may have a pulldown menu 230, a toolbar 240, or some other user interface listing various functions that may be performed on the data displayed by the programs. Each program may have a header 250 describing the program. The first program 210 may display a set of data 260 including a subset of data 270 that a user wishes to transfer to a set of data 280 of the second program 220. The user may select the subset of data 270 using a number of methods known in the art, such as highlighting the data with a mouse, cursor keys, a light pen, or other methods. The selected subset of data 270 may have a set of associated metadata 290. The subset of data 270 may be transferred from the first set of data 260 to the second set of data 280 using a number of common transfer functions known in the art, such as a cut-and-paste function, a copy-and-paste function, a drag-and-drop function, or other method. In an alternative embodiment, the data 270 may be transferred within a first location in the first set of data 260 to a second location in the first set of data 260. Simultaneous with the transfer of the subset of data 270, the metadata 290 may be disassociated from the subset of data 270.

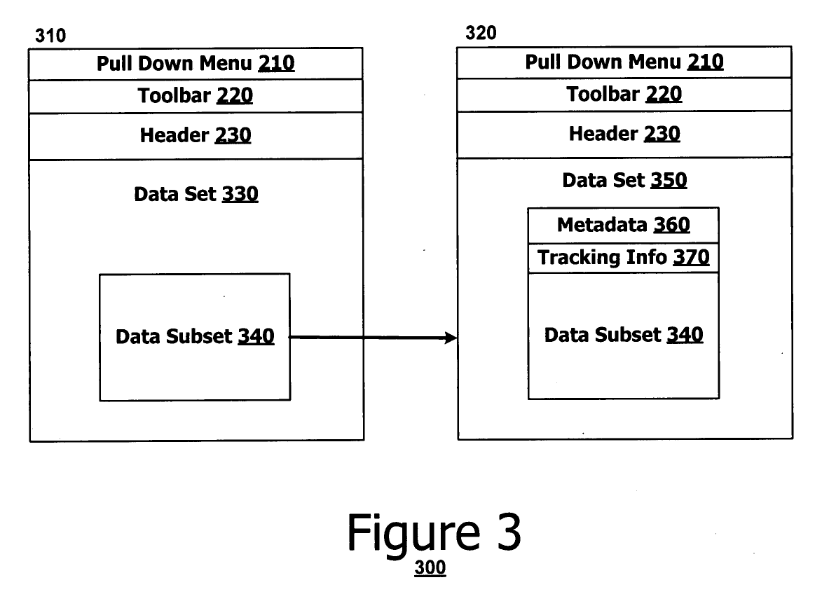

FIG. 3 illustrates in a block diagram one embodiment for a method 200 of adding metadata. Again, a computer system 100 may be executing a first program 310 and a second program 320. The first program 310 may display a set of data 330 including a subset of data 340 that a user wishes to transfer to a set of data 350 of the second program 320. In an alternative embodiment, the data 340 may be transferred within a first location in the first set of data 330 to a second location in the first set of data 330. Simultaneous with the transfer of the subset of data 270, metadata 360 may be associated with the subset of data 340. The added metadata 360 may include tracking information 370 regarding the source of the data 340, such as file name, file type, program type, time and date of transfer, and user.

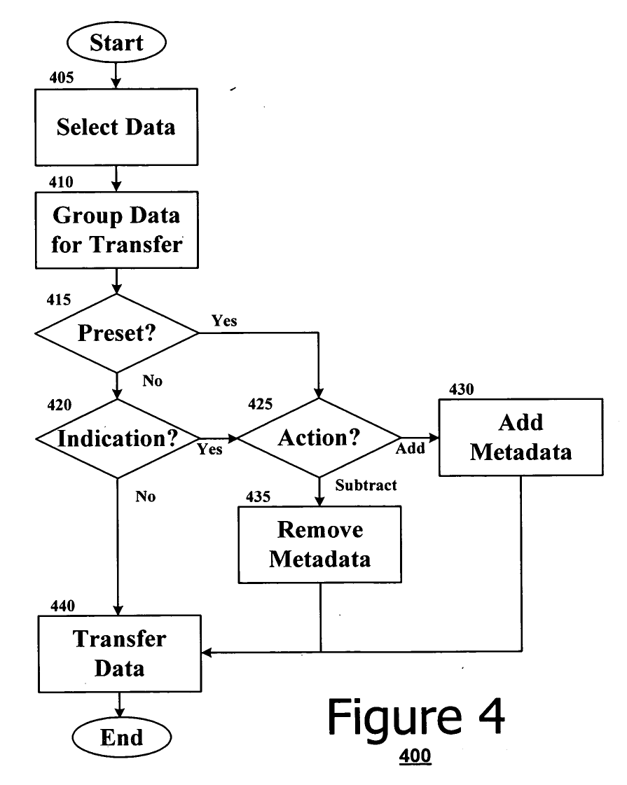

FIG. 4 illustrates in a flowchart one embodiment of a method 400 for altering metadata simultaneous with the transfer of data. The user may select a subset of data (Block 405), which may then be duplicated for transfer from a first location to a second location (Block 410). The user may have a preset metadata setting indicating that every time data is to be transferred the metadata is to be altered in the same way (Block 415). The user may also indicate at the time of transfer that metadata is to be altered in a way specific to that transfer (Block 420). The transfer function may then alter the metadata (Block 425), either adding metadata (Block 430) or removing metadata (Block 435). The data may then transfer the metadata from the first location to the second location (Block 440).

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. In a computer system, a method comprising:
duplicating a subset of data from a first location in a first set of data for a first metadata-capable software application;
automatically altering a set of metadata associated with the subset of data; and
adding the subset of data to a second location.

2. The method of claim 1, further comprising receiving during duplicating an indication of a type of alteration to be performed on the set of metadata.

3. The method of claim 1, further comprising receiving from a user a preset type of alteration to be performed on the set of metadata.

4. The method of claim 1, further comprising removing the set of metadata from the subset of data.

5. The method of claim 1, further comprising appending tracking information to the set of metadata to indicate an origination for the subset of data and a user.

6. The method of claim 1, wherein the second location is in a second set of data.

7. The method of claim 1, wherein the second location is in the first set of data.

8. Computer readable medium storing a set of program instructions that, when executed by a client device, cause the client device to:
duplicating a subset of data from a first location in a first set of data for a first metadata-capable software application;
automatically altering a set of metadata associated with the subset of data; and
adding the subset of data to a second location.

9. The set of program instructions of claim 8, further comprising receiving during duplicating an indication of a type of alteration to be performed on the set of metadata.

10. The set of program instructions of claim 8, further comprising receiving from a user a preset type of alteration to be performed on the set of metadata.

11. The set of program instructions of claim 8, further comprising removing the set of metadata from the subset of data.

12. The set of program instructions of claim 8, further comprising appending tracking information to the set of metadata to indicate an origination for the subset of data and a user.

13. The set of program instructions of claim 8, wherein the second location is in a second set of data.

14. The set of program instructions of claim 8, wherein the second location is in the first set of data.

15. A data processing system comprising:
a data storage medium to store a first set of data for a first metadata-capable software application; and
a processor to duplicate a subset of data from a first location in the first set of data to a second location and to automatically altering a set of metadata associated with the subset of data.

16. The data processing system of claim 15, further comprising receiving during duplicating an indication of a type of alteration to be performed on the set of metadata.

17. The set of program instructions of claim 8, further comprising receiving from a user a preset type of alteration to be performed on the set of metadata.

18. The set of program instructions of claim 8, further comprising removing the set of metadata from the subset of data.

19. The set of program instructions of claim 8, further comprising appending tracking information to the set of metadata to indicate an origination for the subset of data and a user.

20. The set of program instructions of claim 8, wherein the second location is in a second set of data.
